(19) United States
(12) Patent Application Publication
(10) Pub. No.: US 2005/0018326 A1
(43) Pub. Date: Jan. 27, 2005

(54) Rotary polygon mirror assembly and method for making the same

(76) Inventor: In-ho Yoon, Suwon-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/829,326

(22) Filed: Apr. 22, 2004

(30) Foreign Application Priority Data
Jul. 24, 2003 (KR) 2003-50875

(51) Int. Cl. G02B 26/08

(52) U.S. Cl. 359/877; 359/198

(57) ABSTRACT

A rotary polygon mirror assembly preferably comprising a stator, a rotor assembly rotated by a rotational magnetic force generated by an operation with the stator, a rotary polygon mirror disposed at the rotor assembly and having a plurality of reflecting surfaces respectively provided at outer surfaces thereof, and a fixing member disposed so as to completely cover an upper surface of the rotary polygon mirror, for fixing the rotary polygon mirror to the rotor assembly. The fixing member for fixing the rotary polygon mirror has an enough size to completely cover the rotary polygon mirror. Thus, the air containing contaminants which is flowed to the rotary polygon mirror upon the rotation of the rotary polygon mirror is not directly contacted with the reflecting surface of the rotary polygon mirror.

### CROSS-REFERENCE TO RELATED APPLICATIONS

This application claims the benefit of Korean Patent Application No. 2003-50875 filed Jul. 24, 2003, in the Korean Intellectual Property Office, the disclosure of which is incorporated herein by reference in its entirety.

### BACKGROUND

1. Field of the Invention

The present invention relates to a laser scanning unit used for an image forming apparatus. More particularly, the present invention relates to a rotary polygon mirror assembly of the laser scanning unit.

2. Description of the Related Art

Generally, a rotary polygon mirror assembly is a component of a laser scanning unit used for an electrophotograph type image forming apparatus such as a duplicator, a printer, and so on. A laser beam is typically scanned on a photosensitive medium to form an electrostatic latent image. The rotary polygon mirror assembly comprises a rotary polygon mirror by which a laser beam radiated from a light source like a laser diode is reflected in the range of a desired angle on the photosensitive medium to form an electrostatic latent image having a desired pattern, and a motor for rotating the rotary polygon mirror at a high speed.

An example of the rotary polygon mirror assembly is described in U.S. Pat. No. 6,414,777 to Miyamoto, the entire contents of which is incorporated herein by reference. The conventional rotary polygon mirror assembly comprises a rotary polygon mirror, a base mounted on a motor board, a bearing disposed at the base, a core disposed at the base having a coil wound thereon, a rotational shaft rotatably disposed at the bearing, a rotor frame which is disposed at an upper portion of the rotational shaft so as to be rotated together with the rotational shaft and in which the rotary polygon mirror is mounted, a rotor case coupled to the rotor frame so as to surround the coil, a magnet attached to an inner side of the rotor case so as to operate with the coil and thus generate a rotational magnetic force, and an elastic member for closely contacting the rotary polygon mirror with the rotor frame.

In the conventional rotary polygon mirror assembly as described above, if a power source is applied to the coil, a rotational magnetic force is generated between the coil and the magnet and thus the rotor case is rotated at a high speed. Therefore, the rotor frame and the rotary polygon mirror are also rotated at a high speed, and a laser beam radiated to a reflecting surface of the rotary polygon mirror is reflected to a scanning lens in the extent of the desired angle.

However, in the conventional rotary polygon mirror assembly as described above, when the rotary polygon mirror is rotated at a high speed, air is descended along the reflecting surface of the rotary polygon mirror from an upper side of the rotary polygon mirror at a high speed, and fine dirt contained in the air is attached to the reflecting surface of the rotary polygon mirror. Therefore, when using the conventional rotary polygon mirror assembly for a long time, since the reflecting surface of the rotary polygon mirror can become contaminated. As a result, the printed image can become vague.

In order to prevent the contamination of the rotary polygon mirror by the fine dirt and the flow of air, there had been proposed a solution that hermetically seals an inner portion of the laser scanning unit. However, this solution raises another problem that increases the number of fabricating processes and a fabricating cost.

### SUMMARY

Therefore, it is an aspect of the present invention to provide a rotary polygon mirror assembly in which fine dirt is prevented from being attached to a reflecting surface of a rotary polygon mirror.

To overcome the above described problems, and to achieve the aforementioned aspects and other features of the present invention, there is provided a rotary polygon mirror assembly comprising a stator, a rotor assembly rotated by a rotational magnetic force generated by an operation with the stator, a rotary polygon mirror disposed at the rotor assembly and having a plurality of reflecting surfaces respectively provided at outer surfaces thereof, and a fixing member disposed so as to completely cover an upper surface of the rotary polygon mirror, for fixing the rotary polygon mirror to the rotor assembly.

It is preferred that the fixing member has a larger outer circumferential portion than the upper surface of the rotary polygon mirror so as to protrude from the reflecting surface of the rotary polygon mirror.

Preferably, the rotor assembly comprises a rotational shaft rotatably supported to the stator, a rotor frame disposed at an upper portion of the rotational shaft and having a mounting surface on which the rotary polygon mirror is mounted, and a rotor case disposed at the rotor frame to support a magnet for operating with the stator and generating the rotational magnetic force.

Further, it is preferred that the fixing member is a circular disc spring comprising a coupling hole formed at a center portion thereof, an elastic piece protruded from a circumference of the coupling hole in one direction, and a curved portion protruding in the other direction so as to press the rotary polygon mirror.

Preferably, an outer circumferential portion of the disc spring is inclined downward from a center portion of the disc spring to an outside. Also, it is preferable for the outer circumferential portion of the disc spring to be apart from the upper surface of the rotary polygon mirror.

Furthermore, according to another embodiment of the present invention, there is provided a rotary polygon mirror assembly comprising a printed circuit board, a sleeve fastened to the printed circuit board, a rotational shaft rotatably supported to the sleeve, a coil wound on a core fixed to an outer surface of the sleeve, a rotor frame fixed to an upper portion of the rotational shaft, a rotor case fixed to the rotor frame and having a magnet for operating with the coil and generating a rotational magnetic force, a rotary polygon mirror disposed at the rotor frame and having a plurality of reflecting surfaces respectively provided at outer surfaces thereof, and a fixing member disposed so as to substantially cover an upper surface of the rotary polygon mirror and thus prevent air containing dirt from being contacted with the reflecting surface, for fixing the rotary polygon mirror to the rotor assembly.

### BRIEF DESCRIPTION OF THE DRAWINGS

The above objects and other advantages of the present invention will become more apparent by describing in detail preferred embodiments thereof with reference to the attached drawing figures, in which:

FIG. 1 is a schematic side view showing a structure of a rotary polygon mirror assembly according to an embodiment of the present invention;

FIGS. 2A and 2B are plane and front views of a disc spring of the rotary polygon mirror assembly according to an embodiment of the present invention; and

FIG. 3 is a plane view of the rotary polygon mirror assembly according to an embodiment of the present invention.

It will be understood that in the figures, like reference numerals refer to like features and structures.

### DETAILED DESCRIPTION OF THE PREFERRED EMBODIMENTS

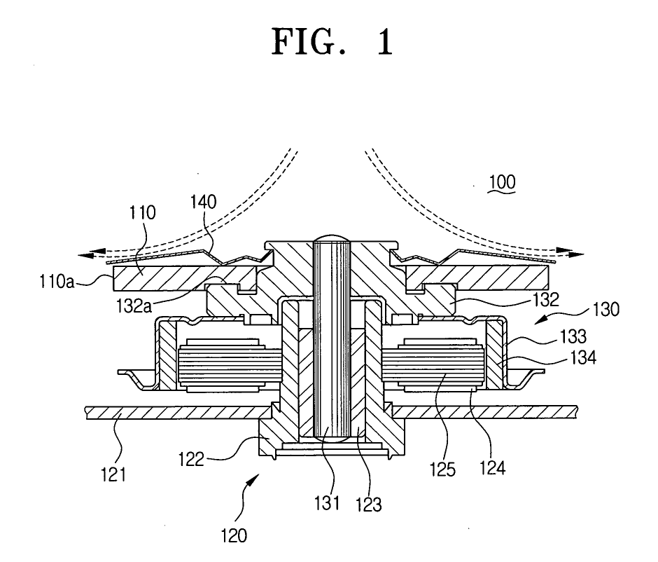

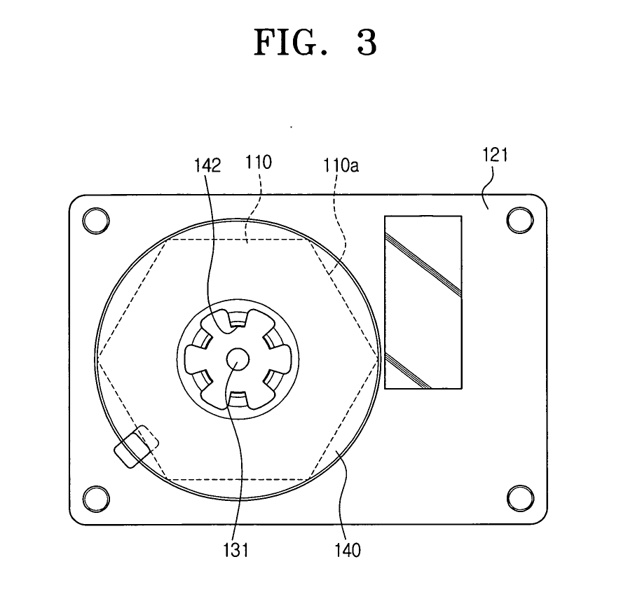

Now, preferred embodiments of the present invention will be described in detail with reference to the attached drawing figures. As shown in FIG. 1, a rotary polygon mirror assembly according to an embodiment of the present invention comprises a rotary polygon mirror 110, a stator 120, a rotor assembly 130 and a disc spring 140. The rotary polygon mirror 110 preferably has the same structure and operation as a conventional one, and also has a predetermined thickness and a through-hole at a center portion thereof. As shown in FIG. 3, the rotary polygon mirror 110 has a hexagonal shape, and a reflecting surface 110a is provided at each of six surfaces formed at an outer circumference of the rotary polygon mirror 110.

The stator 120 includes a printed circuit board 121 on which various electronic components are mounted, a cylindrical sleeve 122 fixed to the printed circuit board 121 while passing through the printed circuit board 121, a bearing 123 inserted into the sleeve 122, a core 124 fixed to an outer surface of the sleeve 122 and a coil 125 having multiple polarities and wound on the core 124.

The rotor assembly 130 comprises a rotational shaft 131 rotatably supported by the bearing 123, a rotor frame 132 fixed to an upper portion of the rotational shaft 131 to be rotated together with the rotational shaft 131, a rotor case 133 coupled to a lower portion of the rotor frame 132 to be extended to a lower portion of the coil 125, and a ring-shaped magnet 134 coupled to an inner portion of the rotor case 133 to operate with the coil 125 and generate a rotational magnetic force. Herein, the rotor frame 132 is made of aluminum so as to be facilely and precisely treated, and provided with a mounting surface on which the rotary polygon mirror 110 is stably mounted. The rotor case 133 can be made of a general metal and is preferably fixed to the lower portion of the rotor frame 132 by a calking process or any other suitable process.

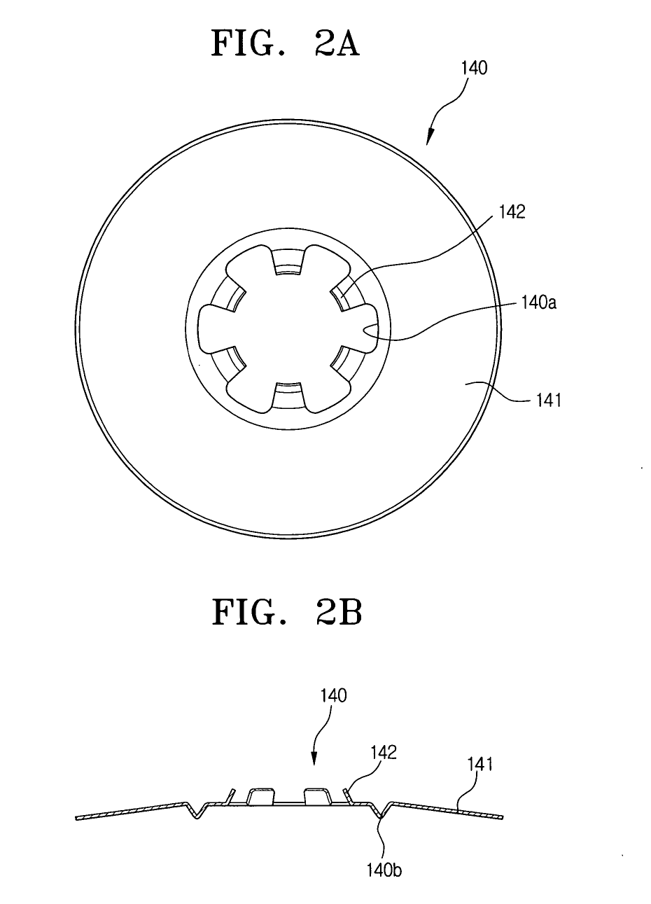

The disc spring 140 is a fixing member for pressing and fixing the rotary polygon mirror 110 to the mounting surface 132a of the rotor frame 132. And as shown in FIGS. 2A to 3, the disc spring 140 is preferably formed by a pressing process and has a circular disc shape in which a coupling hole 140a is formed at a center portion. The disc spring 140 is large enough to completely cover the rotary polygon mirror 110, and an outer circumferential portion 141 is protruded to an outside of the reflecting surface 110a of the rotary polygon mirror 110. Furthermore, the disc spring 140 is provided with a plurality of elastic pieces 142 that are extended upward, and a curved portion 140b that is protruded downward.

As shown in FIG. 1, the plurality of elastic pieces 142 are coupled to a cylindrical upper portion of the rotor frame 132 so as to fixedly keep the disc spring 140 in place. The curved portion 140b is contacted with an upper surface of the rotary polygon mirror 110 so as to press the rotary polygon mirror 110 to the mounting surface 132a of the rotor frame 132. The outer circumferential portion 141 extended from the curved portion 140b of the disc spring 140 to the outside is inclined downward to the outside and gets near to an outer edge of the rotary polygon mirror 110. If the outer circumferential portion 141 of the disc spring 140 contacts the rotary polygon mirror 110 and applies force to the rotary polygon mirror 110, it may have an undesirable effect upon a mounting status of the rotary polygon mirror 110. Therefore, it is preferred that the outer circumferential portion 141 of the disc spring 140 remain apart from the upper surface of the edge of the rotary polygon mirror 110.

Hereinafter, an operation of the rotary polygon mirror assembly 100 according to an embodiment of the present invention will be described. In a process of fastening the rotary polygon mirror 110 with the disc spring 140, the rotary polygon mirror 110 is coupled to the rotor case 132 in a state that the stator 120 and the rotor assembly 130 are completely assembled. When the rotary polygon mirror 110 is mounted on the mounting surface 132a of the rotor frame 132, if the rotary polygon mirror 110 is pressed in a radial direction, a reflecting direction of the laser beam may be changed. Therefore, the pressure should not be applied to the rotary polygon mirror 110 in the radial direction. Then, the disc spring 140 is coupled to the rotor case 132 so that the curved portion 140b presses an upper surface of the rotor case 132. Thus, the rotary polygon mirror 110 is fastened so as to prevent it from moving on the mounting surface 132a of the rotor case 132. The disc spring 140 preferably completely covers the rotary polygon mirror 110, and the outer circumferential portion 141 is protruded to the outside of the edge of the rotary polygon mirror 110 Also, the end of the outer circumferential portion 141 is preferably directed downward.

If electric power is applied to the rotary polygon mirror assembly 100, the coil 125 of the stator 120 and the magnet 134 fixed to the rotor case 133 are operated so as to generate a rotational magnetic force. Accordingly, the rotor assembly 130, the rotational shaft 131 and the rotary polygon mirror 110 are rotated at a high speed. At this time, the laser beam irradiated to the reflecting surface 110a of the rotary polygon mirror 110 is reflected within an extent of a desired angle. And as shown in FIG. 1, the air descended to the rotary polygon mirror 110 by the rotation of the polygon mirror at the high speed is flowed along the inclined upper surface of the disc spring 140 and then flowed to the outside of the rotary polygon mirror 110. Therefore, the air descended at high speed is not directly contacted with the reflecting surface 110a of the rotary polygon mirror 110, and the fine dirt contained in the air is not also attached to the reflecting surface 110a of the rotary polygon mirror 110.

According to the rotary polygon mirror assembly 100 of an embodiment of the present invention as described above, since the disc spring 140 for fixing the rotary polygon mirror 110 has enough size to completely cover the rotary polygon mirror 110, it prevents air from flowing to the rotary polygon mirror upon the rotation of the rotary polygon mirror 110. The flowing air therefore does not directly contact the reflecting surface 110a of the rotary polygon mirror 110. Therefore, the dirt contained in the air is is substantially prevented from becoming attached to the rotary polygon mirror 110.

While the present invention has been described in detail, it should be understood that various changes, substitutions and alterations can be made hereto without departing from the spirit and scope of the invention as defined by the appended claims.

1. A rotary polygon mirror assembly adapted for use with a rotor assembly for rotation by a rotational magnetic force generated by a stator, the rotary polygon mirror assembly comprising:
a rotary polygon mirror disposed at the rotor assembly and having a plurality of reflecting surfaces respectively provided at outer surfaces thereof; and
a fixing member disposed so as to substantially cover an upper surface of the rotary polygon mirror, for fixing the rotary polygon mirror to the rotor assembly.

2. The rotary polygon mirror assembly of claim 1, wherein the fixing member has a larger outer circumferential portion than the upper surface of the rotary polygon mirror so as to be protruded from the reflecting surface of the rotary polygon mirror.

3. The rotary polygon mirror assembly of claim 2, wherein the rotor assembly comprises a rotational shaft rotatably supported to the stator, a rotor frame disposed at an upper portion of the rotational shaft and having a mounting surface on which the rotary polygon mirror is mounted, and a rotor case disposed at the rotor frame to support a magnet for operating with the stator and generating the rotational magnetic force.

4. The rotary polygon mirror assembly of claim 1, wherein the fixing member is a circular disc spring comprising a coupling hole formed at a center portion thereof, an elastic piece protruded from a circumference of the coupling hole in one direction, and a curved portion protruded in the other direction so as to press the rotary polygon mirror.

5. The rotary polygon mirror assembly of claim 4, wherein an outer circumferential portion of the disc spring is inclined downward from a center portion of the disc spring to an outside.

6. The rotary polygon mirror assembly of claim 4, wherein the outer circumferential portion of the disc spring is apart from the upper surface of the rotary polygon mirror.

7. A rotary polygon mirror assembly adapted for use with a rotor frame fixed to a rotational shaft and a rotor case fixed to the rotor frame having a magnet for generating a rotational magnetic force with a coil, the rotary polygon mirror assembly comprising:
a rotary polygon mirror disposed at the rotor frame and having a plurality of reflecting surfaces respectively provided at outer surfaces thereof; and
a fixing member disposed so as to substantially cover an upper surface of the rotary polygon mirror and thus prevent air containing dirt from being contacted with the reflecting surface, for fixing the rotary polygon mirror to the rotor frame.

8. The rotary polygon mirror assembly of claim 7, wherein the fixing member has a larger outer circumferential portion than the upper surface of the rotary polygon mirror so as to be protruded from the reflecting surface of the rotary polygon mirror.

9. The rotary polygon mirror assembly of claim 7, wherein the fixing member is a circular disc spring comprising a coupling hole formed at a center portion thereof, an elastic piece protruded from a circumference of the coupling hole in one direction, and a curved portion protruded in the other direction so as to press the rotary polygon mirror.

10. The rotary polygon mirror assembly of claim 9, wherein an outer circumferential portion of the disc spring is inclined downward from a center portion of the disc spring to an outside.

11. The rotary polygon mirror assembly of claim 9, wherein the outer circumferential portion of the disc spring is apart from the upper surface of the rotary polygon mirror.

12. The rotary polygon mirror assembly of claim 7, further comprising a printed circuit board.

13. The rotary polygon mirror assembly of claim 12, further comprising a sleeve fastened to the printed circuit board and the rotational shaft rotatably supported to the sleeve.

14. The rotary polygon mirror assembly of claim 13, wherein said coil is wound on a core fixed to an outer surface of the sleeve.

15. A method of assembling a rotary polygon mirror assembly having a plurality of reflecting surfaces respectfully provided at outer surfaces thereof, and having a stator and a rotor assembly rotated by a rotational magnetic force generated by the stator, comprising the step of:
attaching the rotary polygon mirror to the rotor assembly with a fixing member adapted to substantially cover an upper surface of the rotary polygon mirror.

16. The method of claim 15, further comprising the step of:
forming said fixing member as a circular disc spring comprising a coupling hole formed at a center portion thereof, an elastic piece protrucing from a circumference of the coupling hole in one direction, and a curved portion protruding in the other direction so as to press the rotary polygon mirror.

17. The method of claim 16, wherein the forming step further comprises forming the circular disc spring such that an outer circumferential portion of the disc spring is inclined downward from a center portion of the disc spring to an outside.

18. The method of claim 16, wherein the forming step further comprises forming the circular disc spring such that an outer circumferential portion of the disc spring is apart from an upper surface of the rotary polygon mirror when the rotary polygon mirror is attached to the rotor assembly.
